(19) United States
(12) Patent Application Publication
(10) Pub. No.: US 2020/0246224 A1
(43) Pub. Date: Aug. 6, 2020

(54) MEDICATION CONTAINER WITH MEDICATION-RELATED INFORMATION AND METHOD FOR FACILITATING MEDICATION-RELATED INFORMATION

(71) Applicant: Armando Amin, Miami, FL (US)

(72) Inventor: Maria Lourdes Rivero, Miami, FL (US)

(21) Appl. No.: 16/850,004

(22) Filed: Apr. 16, 2020

Related U.S. Application Data
(63) Continuation of application No. 11/426,002, filed on Jun. 22, 2006.

(51) Int. Cl. A61J 7/04; G09F 3/00; G09F 3/02

(52) U.S. Cl. CPC A61J 7/04; G09F 3/02; G09F 3/0288

(57) ABSTRACT

According to the preferred embodiment, as depicted in FIG. 1, at least two medication containers (16). A label (32) with indicia (33) and medication-related information (29) is attached to the flat surface (28) of medication containers (16). Indicia (33) and medication-related information (29) of one of said medication containers (16) align and correspond with indicia (33) and medication-related information (29) of the other said medication container (16), and also align with the indicia (33) and medication-related information (29) of any other medication containers (16) that the user may necessitate for storing additional medications. Accordingly, the user will be able to observe medication-related information (29) and indicia (33) of one medication container (16) continuously across medication-related information (29) and indicia (33) of one other medication container, or of several other medication containers (16).

### TYPE OF APPLICATION

Applicant believes that the current application is a “Continuation Application”. However, Applicant respectfully requests Examiner please confirm, if possible, if the application is instead a “Divisional Application”. The parent application is Ser. No. 11/426,002. If Examiner understands that the current application should instead be labeled differently, Applicant requests Examiner please inform Applicant.

### CROSS-REFERENCE TO RELATED APPLICATIONS

This application is related to co-pending, parent application APPARATUS AND METHOD FOR FACILITATING MEDICATION-RELATED INFORMATION, application Ser. No. 11/426,002, filed on Jun. 22, 2006; and to application RACK AND METHOD FOR FACILITATING MEDICATION-RELATED INFORMATION, application Ser. No. 12/715,300, filed on Mar. 1, 2010; and to co-pending application STANDARD RACK WITH MEDICATION-RELATED INFORMATION AND METHOD FOR FACILITATING MEDICATION-RELATED INFORMATION, filed on the day as the current application, in all applications naming Maria Lourdes Rivero as inventor, all said applications incorporated herein by reference in their entirety.

### INTERFERENCE

It is noted that another entity has filed and received a patent claiming the same current invention. That application is Ser. No. 13/389,991, filed on Sep. 11, 2013 according to the application's “Application Data”.

### COPYRIGHT NOTICE

A portion of the disclosure of this patent document contains material which is subject to copyright protection. The copyright owner has no objection to the facsimile reproduction by anyone of the patent document or the patent disclosure, as it appears in patent files or records, but otherwise reserves all copyright rights whatsoever.

### BACKGROUND—FIELD OF INVENTION

This invention relates to the health care field, specifically to an apparatus and method for the purpose of facilitating a user's ability to assimilate medication-related information.

### BACKGROUND—DESCRIPTION OF PRIOR ART

Often times, users of medications struggle with the issue of understanding how to take them properly. The elderly and those with low literacy, for example, can have problems assimilating the medication-related information that is included on medication labels. Therefore, a user may err in the process of consuming a medication, for example, by taking an incorrect dose of medication, or taking it at the incorrect time of day.

Any such errors, or combination thereof, can cause serious health consequences for users. Accordingly, various inventions have been developed to attempt to address the issue of proper medication consumption.

It is well known that conventional pill boxes are available in various shapes and forms, through many drug stores. Additionally, modified pill boxes can provide an incremental degree of benefit.

U.S. Pat. No. 4,693,371 to Malpass shows a pill box with an inner cover and fill cavity for each type of medication, and time of day. In preparing the device for use, a pharmacist or other person will open the inner cover and fill each cavity with an example of the appropriate dosage of medication corresponding to the time of day during which the medication should be taken. Thus, at the start of each day, the patient or other person will pull the appropriate dose of daily medication out of conventional medication containers, and place it in corresponding cavities to match the example within the inner cover of Malpass' pill box. Although Malpass' invention reduces the possibility of error in the case of certain consistent medications, errors are still possible because, depending on the manufacturer, the same medication may come in different shapes, colors, and sizes, particularly when dealing with generic prescription medications.

In general, there are significant disadvantages associated with currently available pill box art. The user of a currently available pill box may be incapable of properly navigating the medication labels in order to match the information on the labels with the information on the pill box. Thus, the user may be unable to stock the pill box. In those cases, a pharmacist or other person must undertake the laborious, and therefore relatively inefficient, process of stocking the medications into the numerous compartments that most pillboxes have in common. Confusion and errors during the process of filling conventional pill boxes can lead to potentially serious consequences for patients. Importantly, it is well known that when patients are confused about medications or when patients experience side effects due to errors related to their medication intake, they are less likely to be compliant.

Conventional medication charts, which list the user's medications as well as medication instructions, help to clarify what medications to take and what medications not to take, but are too abstract for certain users, such as the elderly and those with low literacy. Moreover, a medication chart does nothing to organize the various medication containers that a user may be employing.

Electronic apparatuses of various structures and functions have been developed to address the issue of proper medication consumption. However, these apparatuses are relatively costly and necessitate maintenance.

U.S. Pat. No. 5,031,937 to Nellhaus is considered by Applicant to be prior art since it was referenced in Adler application Ser. No. 13/389,991 and U.S. Pat. No. 9,643,771 (which Applicant perceives to be the same invention as the current application) and, therefore, Applicant is fulfilling Applicant's duty to make Examiner aware. Applicant respectfully submits it should be clear that Nellhaus does not represent obviousness against the current invention, but Applicant will address Nellhaus in order to avoid any potential delays in the current prosecution.

Arguments and Remarks Made by Attorney(s) Prosecuting Adler U.S. Pat. No. 9,643,771

Applicant respectfully requests Examiner please note the arguments and remarks made by the attorney(s) of Adler U.S. Pat. No. 9,643,771, when Examiner reviews same. It should be understood that since the Adler U.S. Pat. No. 9,643,771 is the same invention as the current application, the same arguments in the Adler patent should apply in support of the current invention.

Nellhaus' dosing instructions do not teach the synergistic effect of the dosing instructions of the current invention, a fact that Applicant respectfully submits provides unsurmountable evidence that Nellhaus' patent does not teach the art of the current invention

Applicant respectfully submits that Adler's medication dosing instructions (and all dosing instructions used in pharmacies at the time the current invention was created) do not produce the synergistic effect of the current invention.

The synergistic effect of the current invention, again, is that a user can look across two medication containers, including the label art of the current invention, in a manner that is similar to how a pillbox user reads horizontally across the pillbox, so that the user will be able to easily tell, as a single and relatively undisturbed horizontally continuous dosing message: 1)—what medication to take, 2)—at what time to take it, and 3)—how much of it to take.

Applicant respectfully submits that this fact is evidentiary unsurmountable.

Nellhaus' container-based dosing instructions is a tab 60 attached to the container label, extending away from the label, each tab including an imprinted pillbox matrix with calendar days, time frames, spaces for the placement of instructional stamps 52, and the various instructional stamps 52 attached and scattered about the pillbox matrix. In other words, each Nellhaus medication container label is, in essence, one separate and complete imprinted medication pillbox, with the additional complication of the instructional stamps 52 (not present in ordinary pillboxes). All of said components would interfere with the ability of a person to look across at least two medication containers that encompass the art of the current invention, in a manner that is similar to how a pillbox user reads horizontally across a pillbox, so that the user's ability to tell 1)—what medication to take, 2)—at what time to take it, and 3)—how much of it to take “will be facilitated” (as per the current claims). And particularly since it is well known in the art that there exists a serious issue relating to poor medication adherence, and that medication dosing instructions cause confusion that negatively affects medication adherence, the complexity of Nellhaus' art would render the current invention confusingly inoperable, thus, preventing the synergistic effect of the current invention.

The Nature of the Teaching Is Highly Relevant, A prior art reference that “teaches away” from the claimed invention is a significant factor to be considered in determining obviousness

U.S. Pat. No. 5,031,937 to Nellhaus teaches a grid with time frames and days of the week, the time frames and days of the week arranged in and “L” shaped format, which is the same layout as a standard pillbox. Accordingly, Nellhaus is essentially a standard pillbox grid (or pillbox “photograph”) imprinted onto a label which is then attached to a medication container. Therefore, Nellhaus teaches away, by implicit assertion that the standard pillbox grid represents the only way for medication users to experience the dosing efficacy of a pillbox, as explained in the following sentence. Conversely, the current invention specifically does away with the pillbox grid component, including the days of the week, in order to enable medication users to view dosing time frames and the quantity of medication that a user should consume, across at least two medication containers, in a pillbox-like manner, but facilitated in a continuous and uninterrupted format that enables easier dosing comprehension (this is especially critical, since medication users, particularly elderly patients, have difficulty staying compliant because of medication dosing confusion).

### “THE PROPOSED MODIFICATION CANNOT RENDER THE PRIOR ART UNSATISFACTORY FOR ITS INTENDED PURPOSE”

If proposed modification would render the prior art invention being modified unsatisfactory for its intended purpose, then there is no suggestion or motivation to make the proposed modification. In re Gordon, 733 F.2d 900, 221 USPQ 1125 (Fed. Cir. 1984) (Claimed device was a blood filter assembly for use during medical procedures wherein both the inlet and outlet for the blood were located at the bottom end of the filter assembly, and wherein a gas vent was present at the top of the filter assembly. The prior art reference taught a liquid strainer for removing dirt and water from gasoline and other light oils wherein the inlet and outlet were at the top of the device, and wherein a pet-cock (stopcock) was located at the bottom of the device for periodically removing the collected dirt and water. The reference further taught that the separation is assisted by gravity. The Board concluded the claims were prima facie obvious, reasoning that it would have been obvious to turn the reference device upside down. The court reversed, finding that if the prior art device was turned upside down it would be inoperable for its intended purpose because the gasoline to be filtered would be trapped at the top, the water and heavier oils sought to be separated would flow out of the outlet instead of the purified gasoline, and the screen would become clogged).

### “THE PROPOSED MODIFICATION CANNOT CHANGE THE PRINCIPLE OF OPERATION OF A REFERENCE”

If the proposed modification or combination of the prior art would change the principle of operation of the prior art invention being modified, then the teachings of the references are not sufficient to render the claims prima facie obvious. In re Ratti, 270 F.2d 810, 813, 123 USPQ 349, 352 (CCPA 1959) (Claims were directed to an oil seal comprising a bore engaging portion with outwardly biased resilient spring fingers inserted in a resilient sealing member. The primary reference relied upon in a rejection based on a combination of references disclosed an oil seal wherein the bore engaging portion was reinforced by a cylindrical sheet metal casing. Patentee taught the device required rigidity for operation, whereas the claimed invention required resiliency. The court reversed the rejection holding the “suggested combination of references would require a substantial reconstruction and redesign of the elements shown in [the primary reference] as well as a change in the basic principle under which the [primary reference] construction was designed to operate.”).

Nellhaus' container-based dosing instructions is a tab 60 attached to the label of medication containers, extending away from the label and container, each tab including an imprinted pillbox matrix with calendar days, time frames, spaces for the placement of instructional stamps 52, and the various instructional stamps 52 attached and scattered about the pillbox matrix. This enables users of Nellhaus' art to operate each Nellhaus medication container like a separate pillbox. Removal of said imprinted pillbox matrix with calendar days, plus the instructional stamps 52, would not allow said separate pillbox operation, and therefore render Nellhaus invention inoperable.

### Objects and Advantages

Accordingly, the objects and advantages of the present invention are:
(a) to provide an apparatus and method which will facilitate, in other words help, a user's ability to assimilate medication-related information, without the relatively high level of labor that is necessitated to stock conventional pillboxes, and
(b) to provide an apparatus and method which will facilitate a user's ability to assimilate medication-related information, without the possibility of confusion and consequential errors that are associated with filling currently available pill boxes, and
(c) to provide an apparatus and method which will facilitate a user's ability to assimilate medication-related information, at a reasonable level of cost, and
(d) to provide an apparatus and method which will facilitate a user's ability to assimilate medication-related information, without the confusion that is associated with medication charts.

Further objects and advantages will become apparent upon further study of the balance of this application.

### SUMMARY OF INVENTION

According to the preferred embodiment, at least two labels with indicia and medication-related information are attached, one each, to at least two medication containers. The indicia and medication-related information on the label of at least one medication container aligns with corresponding indicia and medication-related information on the label of at least one other medication container. Accordingly, the user will be able to observe the medication-related information on at least one medication container, and also continuously observe the corresponding medication-related information of at least another medication container. For example, if the user notes on the medication-related information of one medication container, in the morning time frame, the dosing information TAKE 1, the user will be able to continuously view the generally aligned and corresponding medication-related information of the morning time frame of at least one medication container to search for the corresponding medication-related information, such as TAKE 1, or a blank space if no medication is to be taken during the morning time frame for that other medication.

### DESCRIPTION OF DRAWINGS

FIG. 1 is an isometric view showing a preferred embodiment medication container, the medication container alternatively placed on a medication rack with towers, cavities, and a marker.

FIG. 2 is an isometric view of an alternative embodiment showing a medication rack with towers, medication container support, and medication containers with plaques.

FIG. 3 is an isometric view of an alternative embodiment showing a medication rack with towers, medication container support with a label, and medication containers with plaques.

FIG. 4 is an isometric view of an alternative embodiment showing a medication rack with a medication container support, and medication containers with plaques.

FIGS. 5A and 5B are elevation views of alternative embodiments showing medication containers with plaques.

FIGS. 6A and 6B are elevation views of alternative embodiments showing medication racks, and medication containers with plaques.

FIG. 7A is an elevation view of a medication container and a corresponding pillbox.

FIG. 7B is an isometric view of the corresponding pillbox.

FIG. 8A is an isometric view of an alternative embodiment medication container, showing interaction with a second identical medication container.

FIG. 8B is a sectional view of an alternative embodiment medication container, showing interaction with the second identical alternative medication container.

### DESCRIPTION OF THE INVENTION

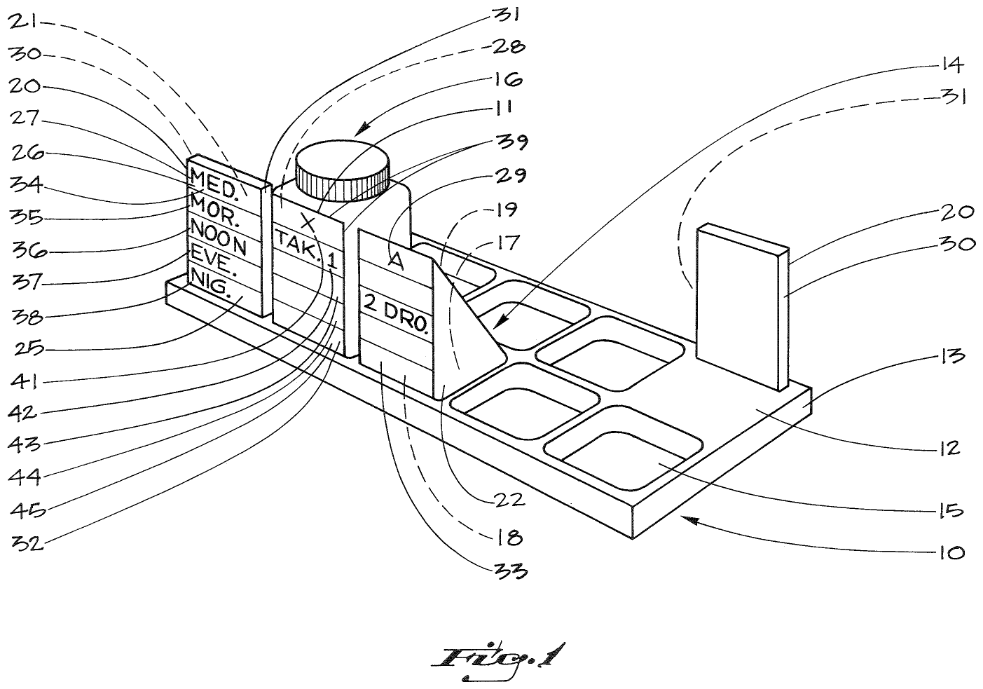

According to the preferred embodiment, FIG. 1 shows medication container 16, which is preferably conventional, of the four flat-side type (FIG. 1 shows container 16 alternatively placed on a rack 10). For efficiency, container 16 is preferably comprised of a single size that is large enough to sustain any 30-day supply of pills. Container 16 includes a label 32, preferably of conventional pharmacy grade. Container 16 also preferably includes another separate conventional label with conventional pharmacy/medication information, as conventionally done, or the conventional pharmacy/medication information can be included within a larger fold-around label 32. The height of label 32 is equal to the height of container 16, extending from an upper edge 11 of flat surface 28, to the bottom of container 16, minus the measure of the depth of cavity 15. Label 32 is positioned on the flat surface 28 of medication container 16, lined-up with three edges 39 of the flat surface 28 of container 16, starting from the upper edge 11. Indicia 33 and medication-related information 29 are provided on label 32, preferably imprinted. Label 32 and imprinting related to indicia 33 and medication-related information 29 are preferably of conventional pharmacy grade. Label 32 of container 16 generally levels with label 32 of at least one other container 16 when medication containers 16 are placed next to each other. Indicia 33 and medication-related information 29 of medication container 16 are arranged so that they generally align, and correspond with indicia 33 and medication-related information 29 another label 32 of at least one other container 16. Indicia 33 preferably include five spaces: a space 41, a space 42, a space 43, a space 44, and a space 45, and each space is covered by a band of a different color. The preferred band colors covering the spaces are: white for space 41, light blue for space 42, yellow for space 43, purplish-orange for space 44, and grey or black for space 45. With the exception of white in space 41, the specific colors are intended to approximate the natural colors of each time period, for example, grey or black for an evening time period. Spaces 41, 42, 43, 44, and 45 are evenly divided within label 32, and generally align with spaces 41, 42, 43, 44, and 45 of the label 32 of at least one other container 16. The colors of the spaces of indicia 33 and indicia 26 which align also match. The five indicia 33 spaces of container 16 include medication-related information 29 which is specific for each medication. For example, as depicted in FIG. 1, if a medication named “X” is to be taken by a user in the morning, medication-related information 29 “X” will be included in indicia 33 space 41 of container 16, and the medication-related information 29 “X” and indicia 33 space 41 will align and correspond with medication-related information 29 of another container 16 that carries, for example, a medication named “Y” included in indicia 33 space 41 of the other container. (For the purpose of the present invention, that medication-related information 29 “X” of one container 16, and medication-related information 29 “Y” of another container 16 will “align”, or “generally align”, means that both medication names—“X” and “Y”—will be generally in line horizontally, so that the user will be able to more easily follow and read both medication names horizontally across the two containers 16, therefore facilitating the user's ability to assimilate both medication names as a united message; that indicia 33 space 41 of container 16 with medication “X”, and indicia 33 space 41 of the other container 16 carrying medication “Y” will “align” means that both spaces 41 each of the two containers 16 will be generally in line horizontally, thus to help guide the user to be able to more easily follow and read medication-related information 29 of the container 16 with medication “X” and medication-related information 29 of the container 16 with medication “Y” across both containers 16; that “X” will “correspond” to “Y” means that the two medication names are synergistically related, in other words, the user will recognize that he/she is viewing medication names across at least said two containers 16 while being guided across the two containers 16 by said at least two medication names “X” and “Y”; that indicia 33 space 41 of the medication container 16 carrying medication “X” will “correspond” to indicia 33 space 41 of the medication container 16 carrying medication “Y” means that both indicia are related by the intended order; in other words, container 16 carrying medication “X” includes five spaces that are intended to align with the five spaces which are included in the container 16 carrying medication “Y”, and because space 41 is the first space of the container 16 carrying medication “X”, from the top down, then that space 41 corresponds to the first space of the container 16 carrying medication “Y”, from the top down which is space 41 of that container 16. Moreover, the terms “aligned”, and “generally aligned”, refer to any level of alignment that facilitates an intended task of the present invention, such as the user viewing both medication names, as described above, horizontally across both said containers 16, and assimilating both medication names as a united message). If the same medication “X” is to be consumed only in the morning, in the form of a single pill, then medication-related information 29 of medication container 16 which contains medication “X” will include the medication-related information 29 “TAKE 1” (abbreviated on FIG. 1 as “TAK. 1”, for clarity) in space 42 (since the user will understand that space 42 is associated with the morning dose) which will align and correspond with space 42 of the container 16 carrying medication “Y”, which will contain medication-related information 29 “TAKE 1” if medication “Y” is also to be consumed in the morning, in the form of a single pill; or, space 42 of the container 16 carrying medication “Y” will be blank if no medication is to be taken during that time frame, but will be taken during another time frame. The medication-related information 29 of spaces 43, 44, and 45 of container 16 of medication “X”, will preferably be blank, since no pills are to be taken during these time frames.

Referring again to FIG. 1, in situations wherein non-pill medications such as ointments, drops, and inhalers are to be consumed by a particular user, a marker 14 can be employed, particularly in those situations wherein the non-pill medications cannot be physically contained within container 16 because of size constraints. For example, marker 14 refers a user to apply two drops (“2 DRO.”) of a drop medication named “A”, as noted on space 43 of label 32. Marker 14 includes a bottom area 17 which matches the bottom area of container 16, thus marker 14 can be pegged into cavities 15 in the same manner as container 16, and marker 14 is interchangeable with container 16. Marker 14 also includes a frontal face panel 18 which is perpendicular with bottom 17. The height of frontal face panel 18 is equal to the height of container 16, extending from the bottom of container 16 to an upper edge 11 of flat surface 28. Marker 14 matches the width of flat surface 28 of container 16. Label 32, including indicia 33 and medication-related information 29, is attached to marker 14 in the same manner as container 16. Also extending from bottom 17 are a rear face panel 19, and two side walls 22. Rear face panel 19 tapers to join frontal face panel 18. The two walls 22 join rear face panel 19 and frontal face panel 18. Marker 14 is preferably made of out hollow injection molded plastic.

FIG. 1 further illustrates an alternative rack 10 which is preferably rectangular. Rack 10 includes a base 12. An integral peripheral edge 13 is about 10 mm. high, and supports base 12. The width of base 12 preferably accommodates two rows of a plurality of cavities 15. Cavities 15 are integral with base 12, are indented about 3 mm. from edge 13, and are structured, in other words sized and shaped, to sustain a conventional medication container 16, and to level medication container 16 with a tower 20. Since conventional container 16 is generally square shaped, cavities 15 are, accordingly, generally square shaped, and about 10 mm. deep. The length of base 12 preferably accommodates tower 20, and a single row of cavities 15, maximizing the number of cavities 15, thus enabling medication rack 10 to preferably fit length-wise inside a standard kitchen top-cabinet. Therefore, rack 10 will preferably include four or five cavities 15 per row. However, rack 10 can be designed to accommodate additional, as well as fewer, cavities 15, depending upon the medicinal needs of a user of medications. Base 12 includes two integral and perpendicular towers 20, located at diagonal ends of base 12. Towers 20 are rectangular, hollow, and about 5 mm. thick. For uniformity, the widths of towers 20 are preferably equal to the width of a flat surface 28 of container 16. However, the widths of towers 20 can be designed to accommodate the width of medication-related information 27. The height of towers 20 is equal to the height of container 16, extending from an upper edge 11 of flat surface 28, to the bottom of container 16, minus the measure of the depth of cavity 15. Towers 20 have a face panel 21 that is indented about 3 mm. from edge 13. The side 30 of tower 20 that is closest to edge 13 is indented from edge 13 a distance that matches the distance between two flat surfaces 28 of containers 16, measured when adjoining containers 16 are pegged into cavities 15. The same distance separates the opposite side 31 of tower 20 from the flat surface 28 of container 16, measured when container 16 is pegged in the adjoining cavity 15. A preferably self-adhesive label 25, equal in size to face panel 21, is attached to at least one tower's 20 face panel 21. Label 25 will preferably be made of coated paper, or any other durable material. Indicia 26 and medication-related information 27 are provided on label 25, preferably imprinted, and generally level with label 25. Indicia 26 and medication-related information 27 are arranged to generally align and to correspond with indicia 33 and medication-related information 29 of container 16. Indicia 26 include five horizontal spaces which are arranged vertically, preferably evenly divided within label 25: a space 34, a space 35, a space 36, a space 37, and a space 38. Indicia 26 also include a band of a different color which covers each of the four spaces. The preferred band colors covering the spaces are: white for space 34, light blue for space 35, yellow for space 36, purplish-orange for space 37, and grey or black for space 38. With the exception of white in space 34, the specific colors are intended to approximate the natural colors of each time period, for example, grey or black for an evening time period. Medication-related information 27 is contained within the five indicia 26 spaces; including a descriptive term pertaining to medication names, and four preferably standard time frames such as: “MEDICATION” in space 34 (abbreviated on FIG. 1 as “MED.”, for clarity), “MORNING” in space 35 (“MOR.”), “NOON” in space 36, “EVENING” in space 37 (“EVE.”), and “NIGHT” in space 38 (“NIG.”). Rack 10 is preferably hollow, and constructed of injection molded plastic, about 3 mm. in thickness.

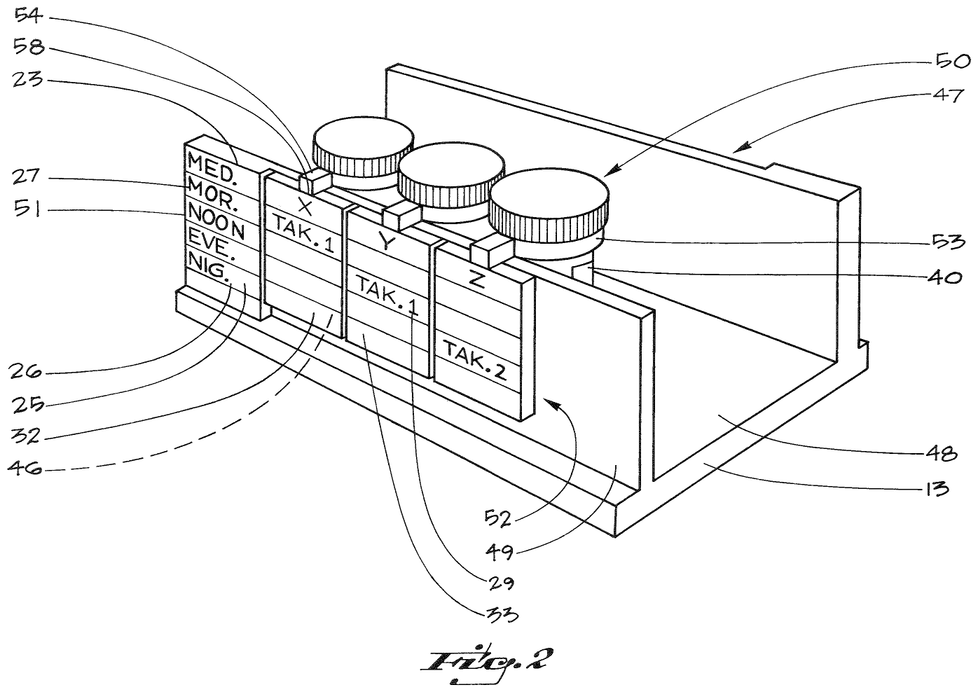

FIG. 2 illustrates an alternative rack embodiment. A medication rack 47 has the same structure as medication rack 10, with the exception that a base 48 of medication rack 47 does not have cavities 15 to sustain a conventional medication container 50. Instead, rack 47 has a support 49 on both sides of base 48 to sustain medication containers 50. Additionally, a tower 51 has the same structure as tower 20, except that tower 51 is about 10 mm. higher that the height of container 50, measured from the neck of container 50 downwards. For uniformity, the widths of towers 51 are preferably equal to the width of a plaque 52. However, the widths of towers 51 can be designed to specifically accommodate the width of medication-related information 27. Label 25 is aligned with the top edge 23 of tower 51. Supports 49 are preferably flat panels, about 5 mm. thick, which are perpendicular, level, and integral with base 48, and extend continuously lengthwise from edge 13 of base 48 to meet tower 51. Supports 49 are indented about 8 mm. from edge 13. The height of supports 49 will match the height of towers 51. The matching heights of supports 49 and towers 51 will enable indicia 33 and medication-related information 29 of medication container 50 to become generally level with the aligned and corresponding indicia 26 and medication-related information 27 of tower 51, when medication container 50 is rested on support 49. The level support 49 will enable the indicia 33 and medication-related information 29 of medication container 50 to become generally level with the aligned and corresponding indicia 33 and medication-related information 29 of any additional medication containers 50 that are rested on support 49. The height of supports 49, and of towers 51, will also be sufficient so that when medication container 50 is rested on support 49, the bottom of medication container 50 will not make contact with base 48, leaving a clearance. Accordingly, base 48 will not interfere with the leveling of containers 50. Label 25, with indicia 26 and medication-related information 27, is size adjusted for accommodating onto tower 51, and is aligned with a top edge 23 of tower 51.

Again, in reference to FIG. 2, medication container 50 is preferably conventional, of the rounded type, and has an attached plaque 52. Plaque 52 is preferably generally flat. For space efficiency, the width of plaque 52 is preferably equal to the diameter of container 50, plus two times the thickness of a ring 53. However, the width of plaque 52 can be designed to accommodate the width of medication-related information 29. The height of plaque 52 is about 10 mm. smaller than the height of container 50, measured from the neck down. However, the height of plaque 52 can be designed to accommodate the height of medication-related information 29. Plaque 52 is hollow, and about 5 mm. thick. An arm 54 extends from the top-center 58 of plaque 52, and connects plaque 52 to ring 53. Arm 54 is about 5 mm. square, and extends about 5 mm. from a face 46 of plaque 52 to ring 53. Ring 53 is perpendicular to plaque 52, and has a thickness of about 5 mm. square. Ring 53 is structured to slip-on to conventional container 50, preferably retained on container 50 by pressure, and to sustain plaque 52 at a distance from medication container 50 that will accommodate the width of support 49, when container 50 is rested on support 49. Ring 53 is also structured so that, as it is being slipped-on to container 50, it stops when it abuts the neck of container 50. Plaque 52, arm 54, and ring 53 are preferably integral, and made of clear injection molded plastic. Attached to plaque 52 is label 32 with indicia 33 and medication-related information 29, size adjusted for accommodating onto plaque 52. A conventional label 40, including general pharmacy/medication information, is preferably positioned on the area of container 50 that is not obstructed by plaque 52.

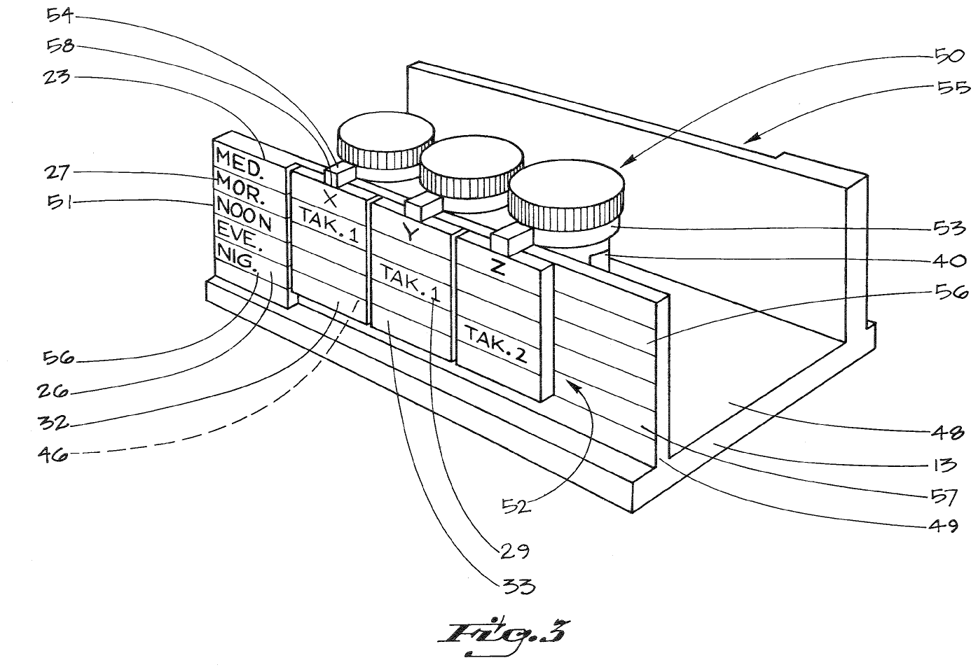

FIG. 3 illustrates another alternative rack embodiment. A medication rack 55 has the same structure as medication rack 47, with the exception that a label 56 with indicia 57 and medication-related information 27 replaces label 25 of tower 51. Label 56, including indicia 57, extends from outermost end of tower 51, throughout the full length of support 49, and is aligned with the top edge 23 of tower 51. With the exception of length, label 56, including indicia 57 and medication-related information 27, is similar to label 25, including indicia 26 and medication-related information 27.

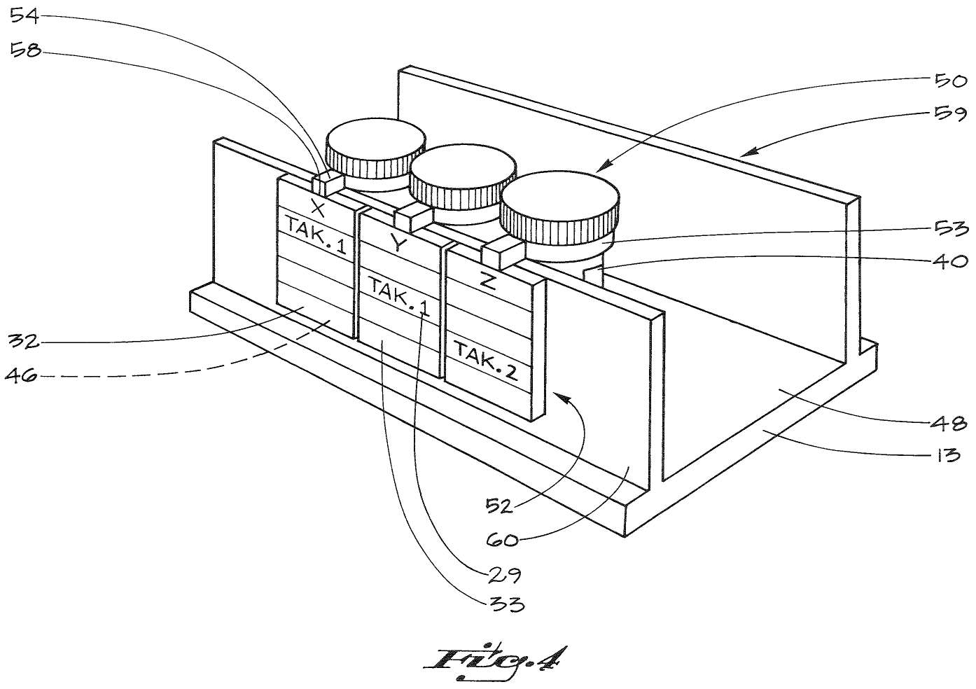

FIG. 4 illustrates another alternative rack embodiment. A medication rack 59 has the same structure as medication rack 47, with the exception that medication rack 59 does not have towers 51. Additionally, a support 60 extends, lengthwise, continuously from edge 13 to edge 13, on both sides of base 48. With the exception of length, support 60 has the same structure as support 49.

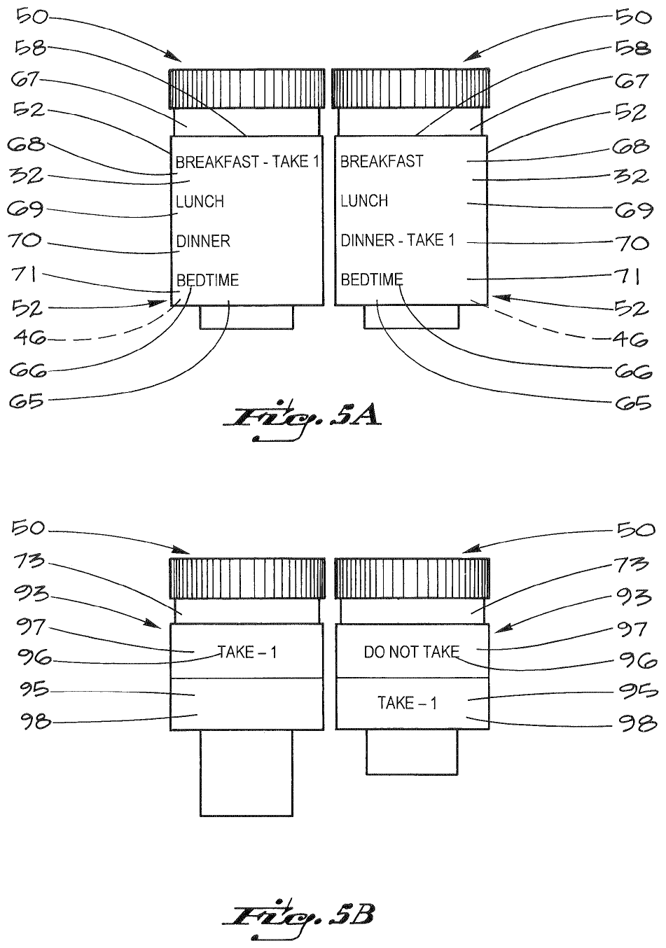

FIG. 5A illustrates another alternative embodiment. Conventional medication containers 50 include plaque 52. Attached to plaques 52 is label 32, including indicia 65 and medication-related information 66. Integral with plaque 52 is a ring 67 which is attached to plaque 52, just above the top center 58 of plaque 52, and reaching the face 46 of plaque 52. Ring 67 has a thickness of about 5 mm. square, and includes a separation which measures about 3 mm. at the opposite end of where ring 67 attaches to plaque 52. Ring 67 is structured to slip-on to conventional container 50, preferably retained by pressure. The separation of ring 67 enables ring 67 to expand and contract, so that plaque 52 can be adjusted up or down along medication container 50, so that medication-related information 66 can be generally leveled with the corresponding and aligned medication-related information 66 of any additional medication containers 50 that the user may necessitate for storing additional medications, when medication containers 50 are preferably placed on a flat surface. Indicia 65 include clear white space, which covers all of label 32. Medication-related information 66 preferably includes four standard medication time frames, such as: a “BREAKFAST” space 68, a “LUNCH” space 69, a “DINNER” space 70, and a “BEDTIME” space 71. Immediately following each time frame is additional medication-related information 66, as applicable, depicting the quantity of medication that is to be taken during that corresponding time frame, such as for example: “TAKE 1”.

FIG. 5B illustrates another alternative embodiment. Conventional medication container 50 includes a plaque 93 which is similar to plaque 52, except that plaque 93 is smaller. A ring 73 is integrally attached to plaque 93. Ring 73 is similar to ring 67, with the exception that ring 73 excludes the 3 mm. separation at the opposite end of where ring 67 attaches to plaque 52. Indicia 95 and medication-related information 96 are imprinted directly onto plaque 93. Medication-related information 96 may include a blank space, indicating that no medication should be consumed, or a worded indication to either consume or not to consume a particular medication. Indicia 95 includes preferably a space 97, and a space 98, representing medications that are to be consumed twice per day. Additionally, indicia 95 include a black line separating spaces 97 and 98, and a grey background imprinted on space 98. Indicia 95 and medication-related information 96 of conventional medication container 50 are arranged to generally align and correspond with indicia 95 and medication-related information 96 of any additional medication containers 50 that the user may necessitate. The conventional medication containers 50 of FIG. 5B are comprised of different sizes.

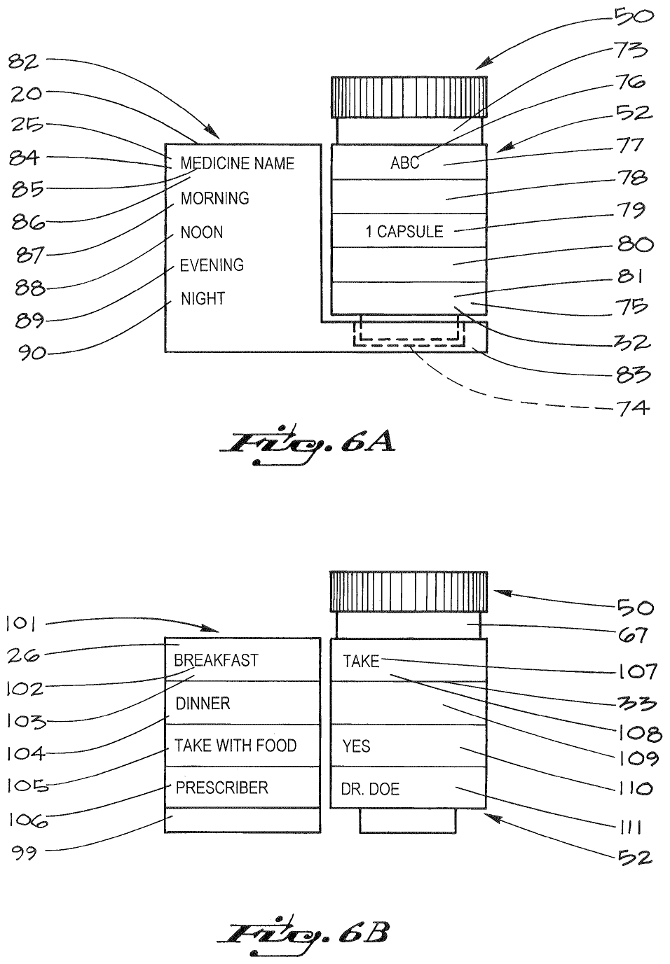

FIG. 6A illustrates another alternative embodiment. Conventional medication container 50 includes plaque 52 and ring 73. Attached to plaque 52 is label 32, including indicia 75 and medication-related information 76. Indicia 75 preferably include five equal yellow spaces, separated by black lines. A space 77 will depict the actual name of the medication. The following four spaces are: a space 78, a space 79, a space 80, and a space 81, depicting medication-related information 76 including, as applicable to each specific medication, the quantity of medication that is to be taken during a given time frame, and a general description of the medication, such as for example, “1 CAPSULE”, which is portrayed on space 79.

Referring again to FIG. 6A, a rack 82 is similar to rack 10, with the exception that rack 82 has a base 83 with a single cavity 74, and one single tower 20. Cavity 74 is similar to cavity 15, with the exception that cavity 74 is structured to accommodate container 50. Tower 20 includes label 25 with indicia 84 and medication-related information 85. Indicia 84 include yellow space, which covers all of label 25. Medication-related information 85 is arranged to align and correspond with medication-related information 76 of container 50. The first medication-related information 85 in a space 86 is “MEDICINE NAME”, corresponding to the actual medication name which will be included in space 77 of container 50, such as, for example, a medication named “ABC”. The following four spaces include four standard medication time frames, such as: a “MORNING” space 87, a “NOON” space 88, an “EVENING” space 89, and a “NIGHT” space 90.

FIG. 6B illustrates another alternative embodiment. A tower 101 is similar to tower 20 except that tower 101 does not rest on base 12. Instead, tower 101 rests on an integral base 99 which has the same dimensions as tower 101, and forms an upside-down “T” with tower 101. Imprinted onto tower 101 are indicia 26 and medication-related information 102. Medication-related information 102, such as “BREAKFAST” on a space 103, “DINNER” on a space 104, “TAKE WITH FOOD” on a space 105, and “PRESCRIBER” on a space 106, is provided on tower 101. Medication-related information 107 and indicia 33 are imprinted on plaque 52. Medication-related information 107, such as “TAKE” on a space 108, a blank area on a space 109, “YES” on a space 110, and “DR. DOE” on a space 111, is provided on container 50. Medication-related information 107 and indicia 33 of container 50 are arranged to align and correspond with medication-related information 102 and indicia 26 of tower 101. Plaque 52 can be adjusted up or down container 50 through ring 67, to generally level medication-related information 107 and indicia 33 of container 50 with medication-related information 102 and indicia 26 of tower 101.

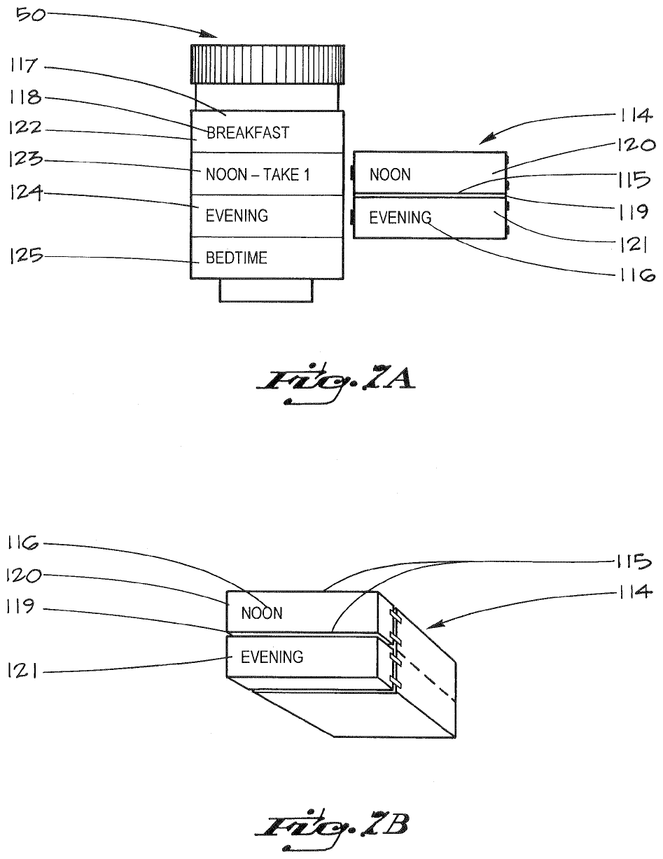

FIGS. 7A and 7B illustrate a corresponding pill box 114, for use along with the racks and medication containers of the present invention. Pill box 114 is conventional in structure, and preferably includes only two medication cavities. Two caps, one for each of the two cavities of pill box 114, are sized to accommodate imprinted indicia 115 and medication-related information 116. Indicia 115 and medication-related information 116 correspond with indicia 117 and medication-related information 118 of container 50. Indicia 115 preferably include a double line 119, comprised of the adjoining physical edges of the two caps of pill box 114. Indicia 115 and medication-related information 116 are similar to indicia 26 and medication-related information 27 of tower 20. Indicia 115 and medication-related information 116 align and correspond with indicia 117 and medication-related information 118 of conventional medication container 50, when leveled. Medication-related information 116 of a first cap includes “NOON” in a space 120. Medication-related information 116 of a second cap includes “EVENING” in a space 121. Medication-related information 118 of container 50 of a medication named “E” include “BREAKFAST” in a space 122, “NOON—TAKE 1” in a space 123, “EVENING” in a space 124, and “BEDTIME” in a space 125. The “NOON” of space 120 of the first cap corresponds with the “NOON—TAKE 1” space 123 of container 50, and the “EVENING” space 121 of the second cap corresponds with the “EVENING” space 124 of container 50. Indicia 117 and medication-related information 118 are similar to indicia 33 and medication-related information 29.

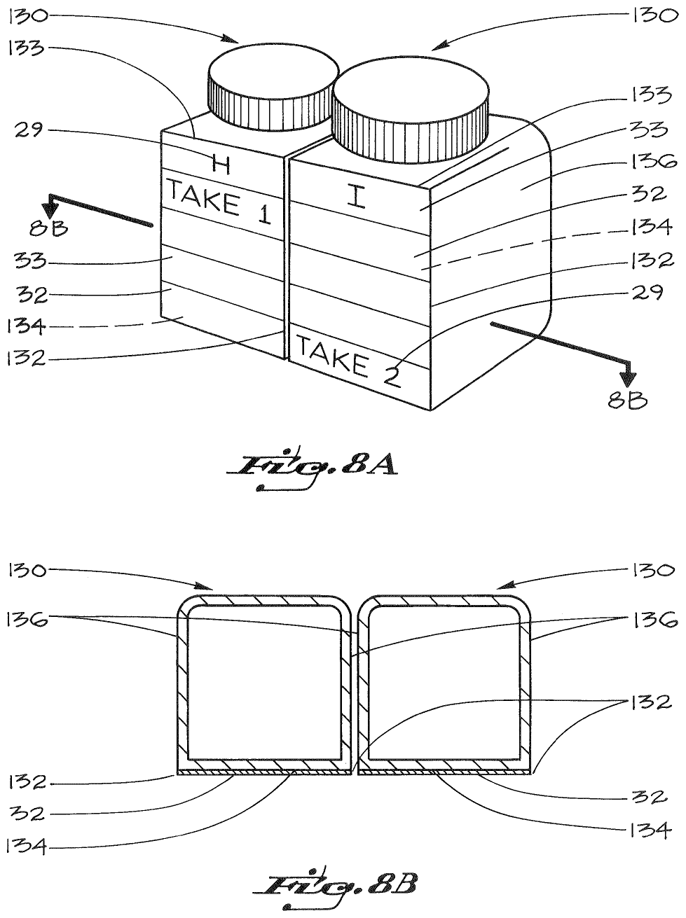

FIGS. 8A and 8B illustrate alternative container 130. Custom-made container 130 is similar to conventional container 16, except that container 130 excludes at least two of the rounded corners which are common in conventional containers 16. Instead, container 130 includes generally sharp corners 132 which are integral with at least a preferably generally flat front panel 134. Two side panels 136 which are generally perpendicular to front panel 134, and integral with sharp corners 132, are generally flat. The generally sharp corners 132 enable the medication-related information 29 and indicia 33, of a plurality of containers 130, to either touch or to be very close together when containers 130 are placed next to each other. Likewise, the generally flat side panels 136 enable the medication-related information 29 and indicia 33, of a plurality of containers 130, to either touch or to be very close together when containers 130 are placed next to each other. This makes it easier for the user to be able to view the medication-related information 29 and indicia 33 horizontally across from one container 130 to another container 130. Container 130 preferably also includes a sharp top edge 133. Top edge 133 is intended to aid the pharmacist or other person to more easily position label 32 on container 130, when attaching label 32 to container 130. The degree of sharpness of corners 132, and edge 133 will preferably balance the safety and comfort of the persons who will manually handle container 130, with the intended purpose of corners 132, and edge 133. Container 130 is more effective than container 16. However, container 130 is more costly to implement because it is custom-made.

### Operation of the Invention

According to the preferred embodiment, as depicted in FIG. 1, the manner of using the present invention includes filling container 16 with a medication, or medications. Medication container 16 may be filled with medication and labeled with indicia 33 and medication-related information 29 by a pharmacist or other person at a retail location, such as a pharmacy. Medication container 16 may alternatively be filled with medication and labeled at any other point of distribution, such as at a medication manufacturer's facilities. In the case of the manufacturer's facilities, the manufacturing process will fill the container. The manufacturer will also generate and place general medication information on a label, and attach that label to medication container 16. Subsequently, a pharmacist or other person at a retail location, or similar, will generate and attach label 32, including indicia 33 and medication-related information 29, to one of the flat surfaces 28 of medication container 16. Label 32 will be positioned on the flat surface 28 of medication container 16, lined-up with three edges 39 of the flat surface 28 of container 16, starting from the upper edge 11. In the case wherein the pharmacist or other person fills the medication container 16, the pharmacist or other person will preferably generate and place label 32 on medication container 16 in the same manner, and also generate and attach preferably another separate conventional label with conventional pharmacy/medication information, as conventionally done. In accordance with the above, any additional medication containers 16 that need to be filled with medications in order to accommodate any additional medication needs of the patient, will also be filled and labeled. By lining-up label 32 with the edges 39 of medication container 16, starting from the upper edge 11, label 32 will be generally be level with label 32 of another container 16 that also is also lined-up with the edges 39 of the other medication container 16, starting from the upper edge 11, when both containers 16 are placed next to each other on a generally flat surface, such as a table (alternatively, containers 16 may be placed on a rack, such as rack 10). Accordingly, label 32 of container 16 will also be level with the label 32 of any additional containers 16 that the user may necessitate for any additional medication needs. Therefore, the medication-related information 29 and indicia 33 of one container 16 will align and correspond with medication-related information 29 and indicia 33 of another container 16, since both labels are preferably printed on the same printer, using the same software, and so that medication-related information 29 and indicia 33 also generally aligns with the corresponding medication-related information 29 and indicia 33 of any additional containers 16 that the user may necessitate. According to conventional pharmacy practice, the pharmacist will also explain and answer any questions regarding the current invention.

Referring again to FIG. 1, the pharmacist or other person may choose to employ marker 14 when container 16 cannot sustain a particular medication because of a constraint, such as size. For example, in a situation wherein a particular user requires use of a drop medication, and the bottle which contains the medication does not fit into container 16, the pharmacist may employ marker 14 by attaching label 32, with the indicia 33 and medication-related information 29 of the particular drops, to marker 14. Accordingly, the user will notice label 32 of marker 14 and will therefore be prompted to apply the drops, even though the drops will not be stored within rack 10, in a manner similar to the consumption of medication from container 16. Marker 14 will prompt the user to seek and to obtain the drops from their storage location, and then to apply the drops. The pharmacist or other person may further choose to attach another label with additional clarifying information onto the rear face panel 19 of marker 14.

In reference to medication rack 10 as depicted in FIG. 1, label 25, including indicia 26 and medication-related information 27, is preferably attached to face panels 21 of towers 20 by the manufacturer of medication rack 10. Alternatively, a pharmacist or other person will attach label 25 to rack 10. The person attaching label 25 to rack 10 may choose to attach label 25 to only one tower's 20 face panel 21. And in situations wherein the user is consuming more medications than the number of containers 16 that can be pegged into one single row of cavities 15, label 25 will be attached to both tower's 20 face panels 21, so that both rows of cavities 15 can be employed. The pharmacist or other person will then preferably peg medication containers 16 into cavities 15 of medication rack 10. Thus, indicia 33 and medication-related information 29 of medication container 16 will be generally level with the corresponding and generally aligned indicia 26 and medication-related information 27 of label 25 of tower 20, and indicia 33 and medication-related information 29 of medical container 16 will also be generally level with the corresponding and generally aligned indicia 33 and medication-related information 29 of any additional medication containers 16 that are pegged into cavities 15, resulting from the user's need for consuming a plurality of medications.

Subsequently, the user of the preferred embodiment, as depicted in FIG. 1, will preferably first look vertically at the vertically arranged medication-related information 27 of one of the two towers 20, of one of the two sides of rack 10, noting and choosing the time frame for which he/she will consume his/her medication or medications. The user will then be able to view continuously, horizontally from left to right, medication-related information 27 of one tower 20 and also the generally aligned and corresponding medication-related information 29 of medication container 16, as well as the generally aligned and corresponding medication-related information 29 of any additional medication containers 16 that are also pegged into cavities 15. The user will be able to repeat the same steps on the other side of rack 10, if there are containers 16 pegged on that side. For example, if a user is to consume his/her morning medication or medications, the user will observe the “MORNING” space 35 of medication-related information 27 of label 25 of tower 20. Then the user will be able to continuously view, the generally aligned indicia 33 and medication-related information 29 on space 42 of label 32 of all of his/her medication containers 16 to specifically select those medications that should be consumed in the morning, also noting the quantity of medication that is to be taken. Accordingly, if the user notes in space 42 of medication-related information 29 of a medication “X” contained in one medication container 16, the designation “TAKE 1”, then the user will know to take one dose of that particular medication as part of his/her morning consumption of medication because space 42 is aligned and corresponds with space 35 medication-related information 27 “MORNING” of tower 20. The user will be able to do the same for his/her noon medications, evening medications, and night medications. Accordingly, the user's ability to assimilate the medication-related information of the present invention will be facilitated. Therefore, the user will be able to take his/her medications without the confusion that is associated with filling conventional pill boxes, or employing medication charts. The present invention also eliminates the cost associated with sophisticated electronic apparatuses.

In addition to facilitating a user's ability to assimilate medication-related information, stocking medication containers 16 into rack 10 also provides a degree of organization for the user.

FIG. 2 illustrates an alternative embodiment. Conventional medication container 50 is filled with medication in the same manner as medication container 16. The general medication information label is attached to conventional medication container 50 in the same manner in which it is attached to medication container 16. However, before the conventional medication label is attached, a pharmacist or other person will slip ring 53, with plaque 52, onto medication container 50, preferably pushing ring 53 until ring 53 abuts the neck of container 50, attaching ring 53 to container 50 preferably by pressure. Label 32, including indicia 33 and medication-related information 29 is attached to plaque 52 in the same manner in which it is attached to the flat surface 28 of medication container 16. Attaching label 32 to plaque 52 enables the user to view continuously the generally aligned and corresponding medication-related information 29 of a plurality of medication containers 50, over the generally flat and therefore more viewable surface of plaque 52, than if label 32 were attached to the circular surface of conventional medication container 50. Ring 53 is preferably blocked from slipping out of container 50 by the thickness of the attached general medication information label.

Referring again to FIG. 2, the operation of medication rack 47 is similar to the operation of medication rack 10, with the exception that medication rack 47 does not have cavities 15 to sustain medication container 50. Instead, the pharmacist or other person will place medication container 50 onto support 49. Ring 53 will rest on support 49, as support 49 is sandwiched between plaque 52 and conventional container 50. The pharmacist, or other person, will preferably place medication container 50 in close proximity to tower 20 so that it will be easier for the user to view indicia 26 and medication-related information 27 of tower 20, and to continuously view indicia 33 and medication-related information 29 of container 50. The pharmacist, or other person, will also preferably place any additional medication containers 50 that the user may necessitate for storing additional medications in close proximity to medication container 50 so that it will be easier for the user to also continuously view indicia 33 and medication-related information 29 of a plurality of medication containers 50. Because the contact made between arm 54 and support 49 provides general leveling between indicia 26 and medication-related information 27 of towers 20, and indicia 33 and medication-related information 29 of containers 50, and because the bottoms of medication containers 50 do not make contact with base 48 of medication rack 47, the general leveling will materialize even if some containers 50 are shorter than others.

FIG. 3 illustrates another alternative embodiment. The operation of medication rack 55 is similar to the operation of medication rack 47, with the exception that there is no need to place medication container 50 in close proximity to tower 51, or to place medication containers 50 close to one another. Plaque 52 of container 50, including label 32, will closely overlap and generally level with label 56 of support 49 when container 50 is rested on support 49. Accordingly, the user will be able to view indicia 57 and medication-related information 27 of tower 20 and continuously view the generally aligned and corresponding indicia 33 and medication-related information 29 of container 50, as well as the aligned and corresponding indicia 33 and medication-related information 29 of any additional medication containers 50 that the user may necessitate for storing additional medications, even if the containers 50 are not placed close to each other, or close to tower 20.

The operation of medication rack 59, as illustrated in FIG. 4, is similar to the operation of rack 47, except that there are no towers 20 to place medication container 50 close to. The pharmacist or other person will place medication container 50 onto support 60, preferably placing container 50 and any additional containers 50 that may be necessitated all in close proximity to each other. Accordingly, the user will be able to continuously observe the generally aligned corresponding indicia 33 and medication-related information 29 of a plurality of medication containers 50. Once communication is given to a user by a pharmacist or other person, and the user understands and memorizes that, when observing indicia 33 and medication-related information 29 of container 50, space 42 pertains to morning, space 43 pertains to noon, space 44 pertains to evening, and space 45 pertains to night, then the user will be able to view continuously, preferably from left to right (although the user may also view from right to left), the aligned and corresponding indicia 33 and medication-related information 29 of a plurality of medication containers 50 to properly select a medication, or medications. For example, if a user is to consume his/her morning medication or medications, the user will observe, horizontally across, the space 42 of all of his/her medications to specifically select those medications that should be consumed in the morning, also noting the quantity of medication that is required. To further clarify, if the user notes in space 42 of medication-related information 29 of label 32 of a container 50 filled with medication “X”, the medication-related information 29 “TAKE 1”, then the user will know to take one dose of that particular medication as part of his/her morning consumption of medication. The user will be able to do the same for his/her noon medications, evening, and night medications.

FIG. 5A illustrates another alternative embodiment. Conventional medication container 50 is filled with medication in the same manner as medication container 16. A pharmacist or other person will slip ring 67 with plaque 52 onto medication container 50, attaching ring 67 to container 50, preferably by pressure. Label 32, including indicia 33 and medication-related information 29 will be attached to plaque 52 in the same manner in which it is attached to flat surface 28 of medication container 16. The pharmacist or other person will adjust ring 67 on containers 50, sliding it up or down containers 50, and on any other containers 50 that the user may necessitate to store additional medications, so that the generally aligned and corresponding medication-related information 29 of plaque 52 of all of the user's medication containers 50 will be level with each other when medication containers 50 are placed on a flat surface, next to each other. The general medication information label will be attached to conventional medication container 50 in the same manner in which it is attached to medication container 16. The general medication label will preferably block ring 67 from slipping out of container 50.

Referring again to FIG. 5A, the user of medication container 50 will place medication containers 50 on a relatively flat surface, next to each other. The indicia 65 clear white space will provide clarity, thus, helping to guide the user to be able to view indicia 65 and medication-related information 66 of medication container 50, as well as the aligned and corresponding indicia 65 and medication-related information 66 of any additional medication containers 50 that the user may necessitate for storing additional medications. For example, if a user is to consume his/her breakfast-time medication or medications, the user will observe the “BREAKFAST” space 68 of medication-related information 66 of label 32, which will include the quantity of medication that is to be taken. Then the user will be able to continuously observe the aligned and corresponding “BREAKFAST” space 68 of medication-related information 66 of label 32 of all his/her medication containers 50, to specifically select those medications that should be administered during breakfast-time. To further clarify, if the user notes in space 68 of medication-related information 66 of a medication “X” stored in container 50, the medication-related information 66 “BREAKFAST—TAKE 1”, then the user will know to take one dose of that particular medication as part of his/her breakfast-time consumption of medication. The user will be able to do the same for his/her lunch medications, dinner, and bedtime medications.

FIG. 5B illustrates another alternative embodiment. The operation of this conventional medication container 50 commences in a manner that is similar to the operation of conventional medication container 50 of FIG. 5A, except that in this alternative embodiment, medication containers 50 are comprised of a plurality of sizes. Moreover, ring 73 is not adjustable. Accordingly, the user must self-level the generally aligned indicia 95 and medication-related information 96 of medication container 50 with the generally aligned and corresponding indicia 95 and medication-related information 96 of any additional medication containers 50 that the user may necessitate. The user may consummate this leveling by manually holding two containers 50, one in each hand and next to each other, and adjusting them accordingly. Once the user has consummated the alignment, the operation of this container 50 becomes similar to the operation of the container 50 of FIG. 4, except that plaque 93 is smaller and will only contain space 97, and space 98, indicative of medications that are consumed twice per day.

FIG. 6A illustrates another alternative embodiment. The operation of this conventional medication container 50 is similar to the operation of the conventional medication container 50 of FIG. 5A, except that in this alternative embodiment, medication container 50 is placed into a single cavity 74 of rack 82. Also, a pharmacist or other person will arrange medication-related information 85 of tower 20 (by employing a computer and printer, or similar) to align with the corresponding mediation-related information 76 of container 50. Especially since container 50 is round, the pharmacist or other person also needs to take care that container 50 is pegged into cavity 74 with plaque 52 facing in the same direction as tower 20, so that labels 32 and 25 can be viewed by the user continuously. The user of rack 82 will be able to use it in a similar manner as rack 10, except that the user will be unable to simultaneously to stock a plurality of medication containers 50 into rack 82. Accordingly, the user can interchange a plurality of containers 50 with different medications in and out of rack 82, as needed.

FIG. 6B illustrates another alternative embodiment. A pharmacist or other person will arrange medication-related information 107 and indicia 33 of container 50 to align and correspond with medication-related information 102 and indicia 26 of tower 101. The operation of this medication container 50 is similar to the operation of medication container 50 of FIG. 5A. A key exception is that although space 108 includes “TAKE”, it excludes the dosage, or quantity, such as “1”. Therefore, the user must either know the dosage, or note the dosage by viewing the general medication information label. The operation of tower 101 is similar to the operation of tower 20, except that tower 101 does not rest on base 12. Tower 101 will preferably be placed on a flat surface by the user. Next to tower 101, the user will place container 50, and the user will also place next to container 50 any additional containers 50 that the user may necessitate for additional medications, thus substantially leveling indicia 33 and medication-related information 107 of containers 50 with the generally aligned and corresponding indicia 26 and medication-related information 102 of tower 101.

FIGS. 7A and 7B illustrate corresponding pill box 114, for use along with the racks and medication containers of the present invention. The user of corresponding pill box 114 will preferably consume the morning dose prior to leaving home. The user will also preferably consume the night dose at home, since it is generally taken prior to going to sleep. Because the noon dose is generally consumed at about lunchtime, and the evening dose is generally consumed at about dinnertime, the user may be out of the home during those time frames. Therefore, the user may choose to employ pill box 114 due to the convenience of portability, as a result of the smaller size of pill box 114 versus rack 10 or containers 50. The process of filling pill box 114 will be made simpler, in comparison to conventional pill boxes, because the user or other person will fill pill box 114 by employing the corresponding indicia and medication-related information of the present invention. Therefore, the confusion that is associated with filling conventional pill boxes will be reduced. The preferred way for the user to consummate the filling process is by, firstly, manually holding pill box 114 and opening the first cap of the “NOON” space 120. Secondly, the user will preferably refer to rack 10 to view the “NOON” space 36 of column 20, and to continuously view all of the containers 16 on rack 10, selecting those containers that indicate a dosing requirement for the noon time period, preferably one-by-one and then replacing each removed container 16 into the rack 10 before the next one is taken out. Accordingly, the user will remove the required dose of medications from each container 16, and deposit the noon medications in the noon cavity of pill box 114, as depicted by “NOON” space 120, then closing the cap until noontime use. The user will repeat the process for the evening medications. Thus, the process of filling pill box 114 will represent less confusion in comparison to conventional pill boxes.

FIGS. 8A and 8B illustrate the operation of alternative, custom-made container 130. The operation of container 130 is similar to that of conventional container 16. However, from the standpoint of the pharmacist or other person who will generate and attach label 32, including indicia 33 and medication-related information 29, to the front panel 134 of medication container 130, the task of attaching label 32 will be easier because the sharp corners 132, and sharp top edge 133 will better guide the pharmacist to position label 32 on container 130, versus the rounded corners of conventional container 16. From the standpoint of the user, container 130 is easier to employ versus container 16 because the sharp corners 132 make it easier for the user to be able to view the medication-related information 29 and indicia 33 horizontally across from one container 130 to another container 130.

### CONCLUSION, RAMIFICATIONS, AND SCOPE OF INVENTION

Thus, the reader will note that the apparatus and method of the present invention will enhance, over the prior art, the user's ability to assimilate medication-related information. And because the racks of the present invention are preferably simple in structure and are preferably constructed of injection molded plastic, the cost involved in production is relatively low. Additionally, the size and manner of production of the medication racks of the present invention make them efficient and effective for distribution at any point wherein medications are distributed to users, such as a pharmacy.

While the above description contains much specificity, these should not be construed as limitations on the scope of the invention, but rather as exemplifications of one preferred embodiment and various alternative embodiments thereof. Many other variations are possible without departing from the scope of the present invention. For example, variations of the medication racks of the present invention can be comprised of any combination of different sizes, materials, and shapes. Within the scope of the present invention, racks are included which require only the part, or parts, which are necessitated for the purpose of leveling the aligned and corresponding indicia and medication-related information of the present invention of any indicia/medication-related information bearing members of the present invention, such as container 50. For example, rack 59 can be exclusively comprised of support 60, by perpendicularly attaching support 60 to a base that sustains support 60. This example of rack 59 would enable the aligned and corresponding indicia 33 and medication-related information 27 of at least two containers 50 to become level. Likewise, medication rack 10 can be exclusively comprised of base 12 with the plurality of cavities 15, which are integral with base 12.

Within the scope of the present invention, towers are included which require only enough structure to sustain the indicia and medication-related information of the present invention, and to level, or support the leveling of, the indicia and medication-related information of the present invention. Accordingly, a tower of the present invention can be exclusively comprised of a generally flat panel, sized to sustain the indicia and medication-related information of the present invention, and an integral stand to support the generally flat panel, in a generally perpendicular orientation, when the panel with the stand is placed on a flat surface, such as a table top. The towers of the present invention may include any combination of the medication-related information and indicia of the present invention.

The indicia of the present invention includes any form of graphics for the purpose of helping to guide the user to view the medication-related information of an indicia/medication-related information bearing member of the present invention, and to continuously view the aligned and corresponding medication-related information of at least one other indicia/medication-related information bearing member of the present invention. The indicia of the present invention may include, for example, lines, colored bands, colored space, clear space, and icons such as arrows. Wherein the indicia include colored bands, for example, as depicted in the preferred embodiment, the indicia generally align between indicia/medication-related information bearing members of the present invention, such as two medication containers 50, because the colored bands are alignable. Wherein the indicia of one, or both, of two indicia/medication-related information bearing members are comprised of, for example, only open or blank pace, as noted in FIG. 5A, the indicia is not alignable. The indicia do not have to match between indicia/medication-related information bearing members. For example, the indicia 84 of rack 82 on FIG. 5B excludes the black lines of indicia 75 of container 50, therefore the indicia do not match. The indicia can be portrayed on various mediums, employing any reproduction method. For example, the indicia can be imprinted on any size and type of label, which then attaches to any indicia/medication-related information bearing member, such as container 16 or tower 20, or the indicia can be imprinted directly onto the indicia/medication-related information bearing member. Also, the indicia can be portrayed electronically. For example, a medication container, or containers, can include any of the indicia and medication-related information of the present invention encoded within an attached radio frequency identification (RFID) tag, or similar. Within this application, for example, the container with the RFID encoded medication-related information 29 and indicia 33 will connect electronically to, and read-out within, an LCD screen, by way of a wired medication rack 10. Once connected, the medication-related information 29 and indicia 33 will automatically level with medication-related information 27 and indicia 26 that appears within the LCD screen. Moreover, the indicia and medication-related information of the present invention does not have to be directly attached to an indicia/medication-related information bearing member. To describe one such possible variation, instead of attaching plaque 52 to medication container 50, plaque 52 with label 32, including indicia 33 and medication-related information 29 can be directly attached to rack 59, close to edge 13, and perpendicular to base 61. Therefore, each preferably conventional medication container would be positioned on rack 59, on the space right behind the plaque 52 that it pertains to. For example, if a user takes two medications, a medication “G”, and a medication “H”, rack 59 will include two plaques 52. Each of the two plaques 52 will include label 32, including indicia 33 and medication-related information 29. A first plaque 52 will include indicia 33 and medication-related information 29 pertaining to medication “G”. A second plaque 52 will include indicia 33 and medication-related information 27 pertaining to medication “H”. The pharmacist or other person will place the container 50 of medication “G” on rack 59, directly behind the first plaque 52. The container 50 of medication “H” will be placed on rack 59, directly behind the second plaque 52. This option is not preferred because once the containers 50 are pulled by the user from rack 59 to consume the contained medication, the user may then confuse which container 50 to return behind which plaque 52. The indicia and medication-related information of the present invention can be portrayed on any type of container, encompassing any shape or form, with a generally flat surface, or a rounded surface, for example. However, portraying the indicia and medication-related information of the present invention on a surface which is not generally flat is not preferred because it is easier for the user to view horizontally, across the indicia and medication-related information of the present invention, of at least two indicia/medication related information bearing members, over a generally flat surface, such as container 130 front panel 134. Indicia 33, as well as all other indicia related to the present invention, and medication-related information 29, as well as all other medication-related information associated with the present invention, can be portrayed onto any indicia/medication-related information-bearing member, by a pharmacist or other person, at any point throughout the various distribution channels of medications, such as at a pharmacy.

Like the indicia of the current invention, the medication-related information of the current invention can be portrayed using various mediums and reproduction methods. The medication-related information of the present invention includes any information that is useful for the purpose of supporting the consumption of medications. This information can be directly or indirectly related to the medication. Accordingly, this information can include, for example, any information relating to the medication package insert, including dosing, side effects, and contraindications. This information can also include any data regarding, for example, the prescribing doctor, such as the doctor's name and phone number, information regarding the pharmacy, or similar, and any combination thereof. The medication-related information of the present invention such as “BREAKFAST” corresponds with medication-related information of the present invention such as “TAKE 1”, for example, when the two appear separately on different indicia/medication-related information bearing members, because the user can view both, “BREAKFAST” and “TAKE 1”, continuously. Therefore, the user's ability to assimilate both as a useable message will be facilitated. Referring to FIG. 5A, “BREAKFAST—TAKE 1” of one of the containers 50 corresponds with “BREAKFAST” of the other container 50 because they are both related in that the user will be able view both continuously to determine what medications, of the two, to take during breakfast. In addition to the corresponding medication-related information, the indicia/medication-related information bearing members of the present invention can also include, within the general area of the corresponding medication-related information, such as within label 32 of container 16, any additional form of information that does not correspond between indicia/medication-related information bearing members. For example, container 16 of FIG. 1 can include additional information such as the name of a dispensing pharmacy, such as “DONE'S PHARMACY”, above space 42, in which case tower 20 would not include corresponding medication-related information 27, such as “PHARMACY NAME” above space 35. This, however, is not preferred because the additional information can be confusing for the user. Most of the corresponding medication-related information of the present invention generally aligns. For example, in FIG. 1 the medication-related information 27 “MORNING” of space 35 of tower 20 aligns with the medication-related information 29 “TAKE 1”, of space 42 of container 16. The exception involves blank spaces, such as space 43 of container 16 wherein medication-related information 29 depicted as a blank space indicates that no medication “X” is to be taken during the corresponding medication-related information 27 “NOON” period of space 36 of tower 20.

The cavities of the present invention can have any structure that sustains the containers of the present invention.

Variations of the medication containers of the subject invention can comprise any combination of shapes, materials, and dimensions. Medication containers, including those of the preferred and the alternative embodiments, of the present invention can include any combination of the medication-related information and indicia of the present invention. The medication containers of the present invention can be sized to contain medicines such as inhalers, ointment tubes, drops, and any other form of medication, or combination of medications thereof. In reference to container 50, as illustrated in FIG. 5A, the pharmacist or other person can adjust the height of ring 67 on container 50 in various ways. For example, the pharmacist can adjust ring 67 on container 50 so that ring 67 locks at a predetermined location on container 50. Therefore, locking ring 67 at a predetermined location on at least two containers 50 would assure leveling of label 32, and alignment of the indicia and medication-related information of the present invention.

The plaques of the current invention are preferably structured so that the plaques can either touch or be very close together when placed onto a rack of the present invention, or on a flat surface. This makes it easier for the user to be able to view the medication-related information and indicia of the present invention horizontally from one container across to another. The plaques of the current invention can be structured to be permanently or removably attached to any medication container or rack of the current invention, by any means. Plaques can be made of any of various materials, and can constitute different shapes and sizes. The plaques of the current invention, the tower panels that sustain the indicia and medication-related information of the present invention, as well as front panel 134 of container 130, are preferably generally flat. However, the plaques, the tower panels, as well as front panel 134, can be curved.

Nevertheless, portraying the indicia and medication-related information of the present invention on a surface which is not generally flat is not preferred because it is easier for the user to view horizontally, across the indicia and medication-related information of the present invention, of at least two indicia/medication related information bearing members, over a generally flat surface, such as container 130 front panel 134.

The medication time frames of the indicia/medication-related information bearing members of the present invention can be outlined within any number of periods. For example, in addition to a “BREAKFAST” space 68, a “LUNCH” space 69, an “DINNER” space 70, and a “BEDTIME” space 71, there are additional medication time frames that are included within the scope of the present invention, such as a “MID-MORNING” time frame. Likewise, fewer times frames can be made to comprise the indicia/medication− related information of any of the indicia/medication-related information bearing members of the present invention. Additionally, the medication time frames of the current invention are explicit. Specifically, “AM”, “8 AM”, “8 AM TO 9 AM”, “MORNING”, and “BREAKFAST” are examples of one time frame of the present invention; and “PM”, “12:00 PM”, “NOON”, and “EVENING” are examples of another time frame of the current invention. The opposite of said examples is, for example: “TAKE TWICE DAILY”, which is not considered a time frame of the current invention. Additionally, the medication time frames of the current invention can be expressed as, for example, “TAKE 1”, or a blank space or the like, as is visible in FIGS. 1, 3, and 4. For the purpose of the present invention, at least two time frames are always arranged in a generally vertical format, as is visible in all FIGS. Marker 14 can be comprised of any structure that: can sustain label 32, or any label/indicia/medication-related information of the current invention; facilitates the user's ability to horizontally view across the medication-related information of marker 14, and of other indicia/medication-related information bearing members that are placed close to marker 14; enables marker 14 to be pegged into cavity 15, or sustained by any of the racks of the current invention, or placed on a flat surface.

Corresponding pill box 114 preferably includes only two medication cavities corresponding to two medication time frames. However, pill box 114 can be comprised of only one, or more than two cavities and time frames. Indicia 115 and medication-related information 116 can be alternatively portrayed on any member of pill box 114, for example, on a side member of pill box 114.

Accordingly, the scope of the invention should be determined not by the embodiments noted, but by the appended claims and their legal equivalents.

What is claimed is:

1. At least two medication containers including printed matter, wherein the improvement includes:
(a) said printed matter comprising at least two substantially horizontally extending indicia, each indicium corresponding to a distinct time frame, and
(b) said at least two indicia located one above the other in a substantially vertical format, so that a lower indicium corresponds to a later time frame than the indicium above it, and
(c) medication-related information comprising a quantity of medication that a user should consume during at least one of at least two explicit time frames is included within the corresponding indicia, and
(d) said at least two indicia of one of said at least two medication containers are substantially horizontally aligned with corresponding said at least two indicia of another one of said at least two medication containers,
whereby said user's ability to view and assimilate said medication-related information comprising said quantity of medication that a user should consume during at least one of at least two time frames across each of said at least two medication containers, is facilitated.

2. The printed matter of claim 1, wherein said printed matter is printed on at least two labels, each label attached to one of said at least two medication containers.

3. The printed matter of claim 1, wherein said medication-related information includes how a medication should be taken in relation to food.

4. The printed matter of claim 1, wherein said medication-related information includes imprinted explicit time frames expressed using at least one word, one number, or one icon.

5. The printed matter of claim 1, wherein said first one of said at least two medication containers further includes indicia of the present invention which substantially aligns with corresponding indicia of said second one of said at least two medication containers.

6. The printed matter of claim 1, wherein said medication-related information includes imprinted explicit time frames expressed as MORNING, NOON or MIDDAY, EVENING, and BEDTIME.

7. The printed matter of claim 1, wherein said printed matter of said first one of said at least two medication containers is substantially aligned with said corresponding printed matter of said second one of said at least two medication containers.

8. The printed matter of claim 1, wherein the at least two substantially horizontally extending indicia are comprised of colored bands, at least one separate color for each indicium, said colors may include white and black, and tones that are representative of the time of day, with said colored indicia of each label attached to each medication container substantially matching the corresponding colored indicia of another label attached to another medication container.

9. The printed matter of claim 1, wherein said quantity of medication that said user should consume during said one of at least two explicit time frames is expressed using at least one word, one number, or one icon.

10. The printed matter of claim 9, wherein said quantity of medication that said user should consume is comprised of the word “TAKE” and a number representing the quantity of medication for the user to consume is included next to, or below, the word “TAKE”.

11. The printed matter of claim 1, further including leveling means to substantially level said printed matter on said first one of said at least two medication containers with said corresponding printed matter of said second one of said at least two medication containers.

12. The printed matter of claim 1, wherein at least one of said at least two explicit time frames is comprised of substantially blank space when no medication is to be consumed during said one of said at least two explicit time frames.

13. The printed matter of claim 1, wherein said substantially horizontal alignment is comprised of adjusting the level of the label of at least said first one of said at least two medication containers.

14. The printed matter of claim 1, wherein each said medication container comprising a hollow body with an integral bottom on one end, and a removably attached cap on the other end.

15. The printed matter of claim 1, wherein said substantially horizontal alignment is comprised of adjusting the level of the printing on the label of at least said first one of said at least two medication containers.

16. A method for conveying the medication-related information of at least one medication contained in a medication container, wherein the improvement includes:
(a) arranging, by a pharmacist or other person, said medication-related information so that said medication-related information will correspond with the medication-related information of another indicia/medication-related information bearing member; and
(b) portraying, by said pharmacist or other person, said medication-related information on said medication container; and
(c) arranging, by said pharmacist or other person, indicia on said medication container so that said indicia will correspond with the indicia of said another indicia/medication-related information bearing member; and
(d) portraying, by said pharmacist or other person, said indicia on said medication container,
whereby said user's ability to view said medication-related information and also continuously view said corresponding medication-related information will be facilitated and, therefore, said user's ability to assimilate said medication-related information and said corresponding medication-related information will be facilitated.

17. The method of claim 24 wherein the pharmacist or other person arranges said medication-related information so that said medication-related information substantially aligns with the medication-related information of said another indicia/medication-related information bearing member.

18. The method of claim 24 wherein the pharmacist or other person substantially levels said medication-related information with the medication-related information of said another indicia/medication-related information bearing member.

19. The method of claim 24 wherein the pharmacist or other person arranges said indicia so that said indicia substantially aligns with the indicia of said another indicia/medication-related information bearing member.

20. The method of claim 24 wherein said another indicia/medication-related information bearing member is comprised of at least one other medication container.

21. The method of claim 24 wherein said another indicia/medication-related information bearing member is comprised of a tower.
